(19) United States
(12) Patent Application Publication
(10) Pub. No.: US 2023/0410186 A1
(43) Pub. Date: Dec. 21, 2023

(54) ALCOHOLIC BEVERAGE PROCUREMENT SYSTEM AND METHOD

(71) Applicant: BAR ME Pty Ltd, Currambine (AU)

(72) Inventor: Daniel Justin Zarb, Currambine (AU)

(21) Appl. No.: 18/034,675

(22) PCT Filed: Sep. 30, 2021
(86) PCT No.: PCT/AU2021/051140

§ 371 Date: Apr. 28, 2023

(30) Foreign Application Priority Data
Oct. 29, 2020 (AU) 2020903917

(51) Int. Cl. G06Q 30/0601; G01C 21/00; G06Q 30/0251

(52) U.S. Cl. CPC G06Q 30/0639; G06Q 30/0261; G01C 21/3811; G06Q 30/0641

(57) ABSTRACT

Provided is an alcoholic beverage procurement system comprising a relational database management computer system arranged in signal communication with a relational database and configured to provide a purvey—or GUI to a suitable processing system of an alcoholic beverage purveyor, whereby such a purveyor is able to i) register a unique profile and ii) populate said profile with alcoholic beverage offerings that comprise various attributes within said relational database. The system further provides a user GUI to a suitable processing system of a user, whereby such a user is able to, in substantial real-time i) provide a GNSS identifier indicative of a geographic location of the user ii) search the relational database for desired alcoholic beverage offerings and iii) receive a visualisation of purveyors offering said desired alcoholic beverage offerings within a predetermined distance from the geographic location of the user.

### TECHNICAL FIELD

This invention broadly relates to the field of computer-implemented systems and methods, in general, and more specifically to an alcoholic beverage procurement system and method.

### COPYRIGHT NOTICE/PERMISSION

A portion of the disclosure of this patent specification contains material that is subject to copyright protection. The copyright owner has no objection to the facsimile reproduction by anyone of the patent specification or parts thereof as it appears in the file or records of a Patent Office, but otherwise reserves all copyrights whatsoever.

### BACKGROUND ART

The following discussion of the background art is intended to facilitate an understanding of the present invention only. The discussion is not an acknowledgement or admission that any of the material referred to is or was part of the common general knowledge as at the priority date of the application.

Alcohol is one of the most widely used recreational drugs in the world, with about 33% of adults worldwide being current drinkers. The global alcoholic drink industry exceeded $1 trillion in 2018 and the discovery of late Stone Age jugs suggests that intentionally fermented drinks existed at least as early as the Neolithic period. As a result, many people enjoy alcoholic beverages on a daily basis and certain cultures incorporate alcoholic beverages as part of social interaction.

In the modern age, online systems, i.e. accessible via the Internet, for alcoholic beverages are known. For example, TAABS™ provides a system for curated content in the form of searchable keywords, insider notes, and professional photos of alcoholic beverages. Similarly, DrinkAdvisor™ and DrinkedIn™ are other applications or ‘apps’ providing bars and drinks guides, generally featuring recommendations and reviews of venues serving alcoholic beverages.

Applicant has identified a need in the art for a means able to provide better guidance to alcoholic beverage enthusiasts, as many such enthusiasts have an affinity for a specific type or brand of alcoholic beverage or beverage recipe which the current state of the art does not cater for. The current invention was conceived with this goal in mind.

### SUMMARY OF THE INVENTION

The skilled addressee is to appreciate that reference herein to ‘the Internet’ generally refers to any suitable communications network and typically includes reference to a global system of interconnected computer networks that use the Internet protocol suite (TCP/IP) to link processing devices worldwide. Such a network includes a network of networks that may consist of private, public, academic, business, and government networks of local to global scope, linked by a broad array of electronic, wireless, and optical networking technologies. In this context, the Internet carries a vast range of information resources and services, such as the inter-linked hypertext documents and applications of the World Wide Web (WWW), electronic mail, telephony, and file sharing.

It is also to be understood that reference herein to a ‘GUI’ refer to a Graphical User Interface, being a user interface that allows a user to interact with an electronic device, such as a terminal, processing or computing system through manipulation of graphical icons, visual indicators, text-based typed command labels and/or text navigation, including primary and/or secondary notations, as is known in the art of computer science.

In addition, reference herein to ‘GNSS’ generally refers to any suitable Global Navigation Satellite System able to provide autonomous geo-spatial positioning, including the GPS, GLONASS, Galileo, Beidou and other regional satellite systems.

It is further to be appreciated that reference herein to ‘substantial real-time’ is to be understood as meaning an instance of time that may include a delay typically resulting from processing, calculation and/or transmission times inherent in computer processing systems and related network transmissions. These transmission and calculations times, albeit of generally small duration, do introduce some delay, i.e. typically less than a second or within milliseconds, but the user is provided with relevant visualisation information relatively quickly or within ‘substantial real-time’.

In accordance with a first aspect of the invention there is provided an alcoholic beverage procurement system comprising a relational database management computer system arranged in signal communication with a relational database and configured to:
provide a purveyor GUI, via the Internet, to a suitable processing system of an alcoholic beverage purveyor whereby such a purveyor is able to:
   i) register a unique profile; and
   ii) populate said profile with alcoholic beverage offerings that comprise various attributes within said relational database; and
provide a user GUI, via the Internet, to a suitable processing system of a user, whereby such a user is able to, in substantial real-time:
   i) provide a GNSS identifier indicative of a geographic location of the user;
   ii) search the relational database for desired alcoholic beverage offerings; and
   iii) receive, from the relational database management computer system, a visualisation of purveyors offering said desired alcoholic beverage offerings within a predetermined distance from the geographic location of the user;
      wherein a plurality of users is able to search a plurality of purveyors' alcoholic beverage offerings and receive real-time indications of availability and associated attributes based on geographic location.

Typically, the alcoholic beverage purveyor is selected from a non-exhaustive group consisting of a bar, a tavern, a club, a restaurant, a pub or similar retail business establishments serving alcoholic beverages.

Typically, the attributes of the alcoholic beverage offerings are selected from a non-exhaustive group consisting of brand, recipe, ingredients, price, quantity, producer, geographic indication of origin, serving style, geographic location, and/or the like.

Typically, the GNSS identifier indicative of a geographic location of the user comprises an output from a GNSS module of the suitable processing system of the user and/or a postcode entry via the user GUI.

Typically, the visualisation of purveyors comprises an interactive map showing the relative position of such purveyors in relation to the geographical location of the user.

In an embodiment, the visualisation of purveyors includes a list of purveyors sortable according to any of the attributes, e.g. price, location, etc.

Typically, the suitable processing system of either the purveyor and/or the user comprises a mobile phone handset, a tablet, a personal computer, or the like.

In an embodiment, the user GUI is configured to include promotional information from at least one purveyor.

In an embodiment, the user GUI is configured to allow a user to comment on an alcoholic beverage offering of a purveyor, said comment stored as an attribute within the relational database.

In accordance with a second aspect of the invention there is provided a computer-implemented method for alcoholic beverage procurement requiring a relational database management computer system arranged in signal communication with a relational database, said management computer system configured to perform the steps of:
providing a purveyor GUI, via the Internet, to a suitable processing system of an alcoholic beverage purveyor whereby such a purveyor is able to:
   i) register a unique profile; and
   ii) populate said profile with alcoholic beverage offerings that comprise various attributes within said relational database; and
providing a user GUI, via the Internet, to a suitable processing system of a user, whereby such a user is able to, in substantial real-time:
   i) provide a GNSS identifier indicative of a geographic location of the user;
   ii) search the relational database for desired alcoholic beverage offerings; and
   iii) receive, from the relational database management computer system, a visualisation of purveyors offering said desired alcoholic beverage offerings within a predetermined distance from the geographic location of the user;
      wherein a plurality of users is able to search a plurality of purveyors' alcoholic beverage offerings and receive real-time indications of availability and associated attributes based on geographic location.

Typically, the alcoholic beverage purveyor is selected from a non-exhaustive group consisting of a bar, a tavern, a club, a restaurant, a pub or similar retail business establishments serving alcoholic beverages.

Typically, the attributes of the alcoholic beverage offerings are selected from a non-exhaustive group consisting of brand, recipe, ingredients, price, quantity, producer, geographic indication of origin, serving style, geographic location, and/or the like.

Typically, the GNSS identifier indicative of a geographic location of the user comprises an output from a GNSS module of the suitable processing system of the user and/or a postcode entry via the user GUI.

Typically, the visualisation of purveyors comprises an interactive map showing the relative position of such purveyors in relation to the geographical location of the user.

In an embodiment, the visualisation of purveyors includes a list of purveyors sortable according to any of the attributes, e.g. price, location, etc.

Typically, the suitable processing system of either the purveyor and/or the user comprises a mobile phone handset, a tablet, a personal computer, or the like.

In an embodiment, the user GUI is configured to include promotional information from at least one purveyor.

In an embodiment, the user GUI is configured to allow a user to comment on an alcoholic beverage offering of a purveyor, said comment stored as an attribute within the relational database.

In accordance with a third aspect of the invention there is provided a method for alcoholic beverage procurement comprising the steps of:
providing a relational database management computer system arranged in signal communication with a relational database;
providing a purveyor GUI, via the relational database management computer system, to a suitable processing system of an alcoholic beverage purveyor;
receiving a unique profile registration from such a purveyor, said profile populated with alcoholic beverage offerings that comprise various attributes within said relational database; and
providing a user GUI, via the relational database management computer system, to a suitable processing system of a user;
receiving, from the user processing system, a GNSS identifier indicative of a geographic location of the user in substantial real-time;
receiving, from the user processing system, a search query for desired alcoholic beverage offerings; and
executing a search on the relational database according to such search query; and
providing, via the relational database management computer system, a visualisation of purveyors offering said desired alcoholic beverage offerings within a predetermined distance from the geographic location of the user.

According to a further aspect of the invention there is provided a computer programme product which, when executed by a suitable processing system, facilitates the performance of the method according to the second or third aspects of the invention above.

### BRIEF DESCRIPTION OF THE DRAWINGS

The description will be made with reference to the accompanying drawings in which:

FIG. 1 illustrates a functional block diagram of an example processing system that can be utilised to embody or give effect to a particular embodiment of a relational database management computer system or a suitable processing system, in accordance with the present invention;

FIG. 2 illustrates an example network infrastructure that can be utilised to embody or give effect to a particular embodiment of a communications network whereby suitable processing systems can be arranged in signal communication;

FIG. 3 is a diagrammatic representation of an alcoholic beverage procurement system, in accordance with as aspect of the present invention; and

FIG. 4 is a functional block diagrammatic representation of method steps for a computer-implemented method for alcoholic beverage procurement, in accordance with an aspect of the present invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above. In the figures, incorporated to illustrate features of the example embodiment or embodiments, like reference numerals are used to identify like parts throughout.

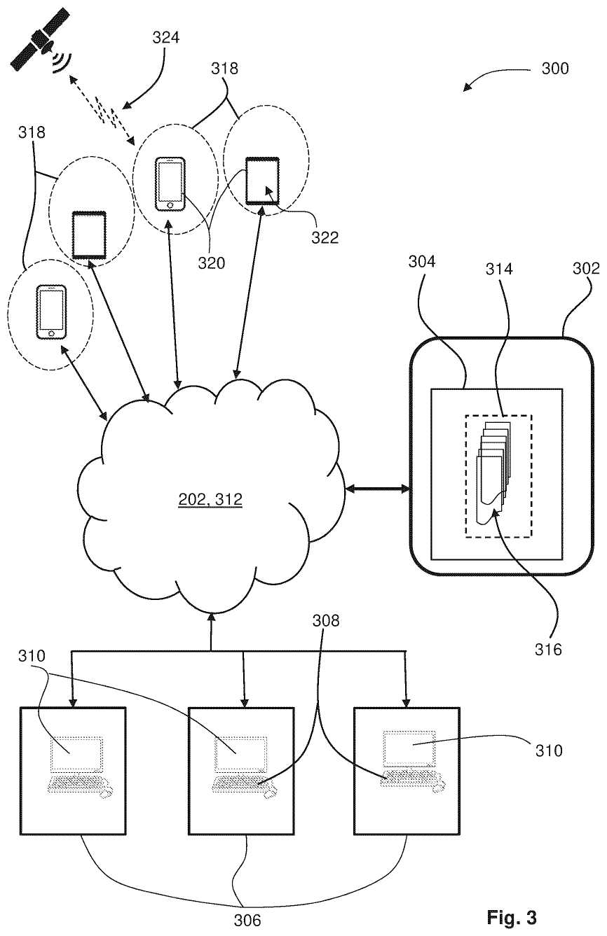

With reference firstly to FIG. 3 of the accompanying drawings, there is shown one broad example of an alcoholic beverage procurement system 300. As described in more detail below, such a system 300 broadly comprises a number of constituent components, including one or more suitable processing systems 302, 308, 320 that are operatively networked together by means of a suitable communications network 312, such as the Internet or the like, in order to fulfil their functions as part of the present invention.

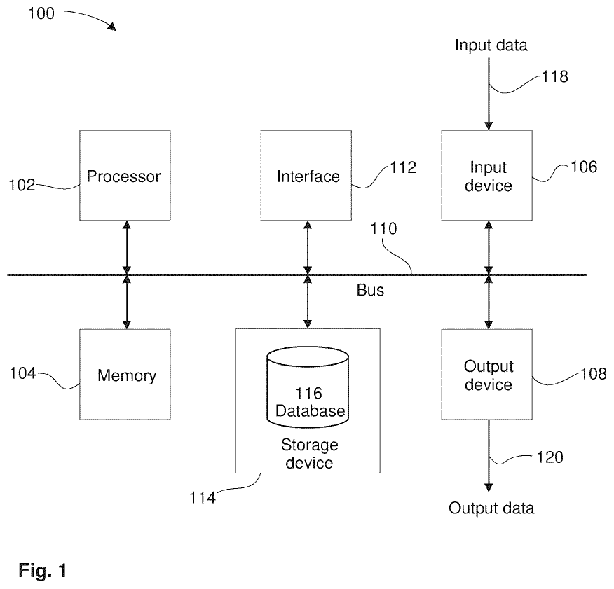

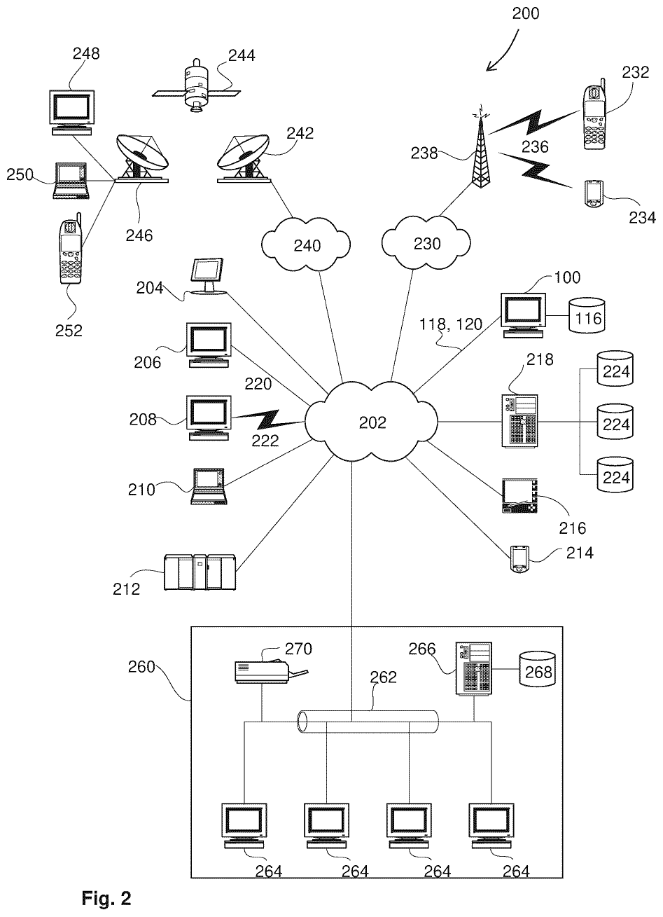

Accordingly, by way of background and with reference firstly to FIGS. 1 and 2 of the accompanying drawings, there is shown a broad example of a processing system 100 that can be used, in different configurations as will be readily apparent to the skilled addressee, to implement a suitable processing system 302, 308, 320, as described in more detail below. Similarly, FIG. 2 shows a broad example of a networked communications system 200 whereby the respective processing and computer systems can be arranged in signal communication, i.e. networked together.

It is to be appreciated that any reference herein to “means” specifically includes any one or more of a computer programme product for use in a local or dispersed computing system, a computer readable modulated carrier signal for interpretation by a local or dispersed computing system, or a computer readable medium of instructions for enabling a local or dispersed computing system to provide such “means” within the context of the description. In addition, such “means” may further expressly comprise any of the hardware and/or software components, independently or in combination, provided for in the description below, as will be understood by the skilled addressee.

Referring now to FIGS. 2 and 3, by way of background, in a general networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may include or be associated with other devices, for example a local data storage device such as a hard disk drive or solid-state drive.

An information source can include a server, or any type of terminal, that may be associated with one or more storage devices that are able to store information or data, for example in one or more databases residing on a storage device. The exchange of information (i.e. the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The Internet 202, which often serves as an enabling part of communications network 200, is the large-scale interconnection of public and private networks. The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network.

Such a network itself may take a variety of forms. For example, it may be a computer network, telecommunications network, data communications network, Local Area Network (LAN), Wide Area Network (WAN), wireless network, Internetwork, Intranetwork, the Internet and developments thereof, transient or temporary networks, combinations of the above or any other type of network providing for communication between computerised, electronic or digital devices. More than one distinct network can be provided, for example a private and a public network. A network as referenced in this specification should be taken to include any type of terminal or other similar type of electronic device, or part thereof, which is rendered such that it is capable of communicating with at least one other terminal.

One example of facilitating communication across such networks, is the Hyper-Text Mark-Up Language (HTML) and Hyper-Text Transfer Protocol (HTTP), and developments thereof, which have made the Internet or World Wide Web (WWW) accessible. The exchange of information on the Internet is further facilitated through hyper-text documents. Hyper-Text documents are unique in that they use tags to define links which, when selected, retrieve the related information from within the same document or from a new document altogether.

The links are defined using HTML which provides a document formatting method which adapts in a consistent manner to any computer on which it is displayed. HTML tags are used to define various components of text, visual or audio which make up a hyper-text document, including such things as formatting and linking to other documents. HTML tags which link documents on one Internet information source to those on another do so by associating a Uniform Resource Locator (URL) with the referenced information. The skilled addressee will appreciate that other communication protocols may be used and are within the scope of the present invention.

Additionally, ss is known in the art of computer programming, an application programming interface (API) is a set of subroutine definitions, communication protocols, and tools for building software. In general terms, it is a set of clearly defined methods of communication among various components. Means for facilitating any of the communications or interactions between suitable processing system 302, 308, 320 via the network 202 may be facilitated via suitable APIs within processing system 100 or network 200, as will be readily apparent to the skilled addressee.

In light of this background, the processing system 100 of FIG. 2 generally includes at least one processor 102, or processing unit or plurality of processors, memory 104, at least one input device 106 and at least one output device 108, coupled together via a bus or group of buses 110. Typically, the processor 102 comprises any suitable processor or microcontroller configured to receive input, perform logical and arithmetical operations on a suitable instruction set, and provide output, as well as transitory and/or non-transitory electronic storage, such as memory 104 and storage device 114, or the like.

In certain embodiments, input device 106 and output device 108 could be the same device, e.g. a touchscreen. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice-controlled activation such as a microphone, data receiver or antenna such as a modem or wireless data adaptor, data acquisition card, a touchscreen for receiving tactile input, etc. Input data 118 could come from different sources, for example keyboard instructions in conjunction with data received via a network, or a dedicated global navigation satellite system (GNNS) sensor, as is known in the art, or the like. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network.

A user could view data output, or an interpretation of the data output, on, for example, a touchscreen, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

As described, the processing system 100 is generally part of a networked communications system 200, as shown in FIG. 3. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with Ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200. Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

Accordingly, in the manner described above, the alcoholic beverage procurement system 300, as well as different versions of user and purveyor processing systems 308, 320 are generally realised by suitable versions of the processing system 100, as described above, and networked together to perform the functions and provide the features broadly described herein.

With reference now to FIG. 3, there is shown an example of the alcoholic beverage procurement system 300 which generally comprises a relational database management computer system 302 arranged in signal communication with a relational database 304.

The relational database management computer system 302 is generally configured to provide a purveyor GUI 310, via the Internet 312, to a suitable processing system 308 of an alcoholic beverage purveyor 306. By means of this GUI 310, a purveyor 306 is able to register a unique profile 314, and populate said 314 profile with alcoholic beverage offerings that comprise various attributes 316 within said relational database 304. It is to be appreciated that the alcoholic beverage purveyor 306 may include a bar, a tavern, a club, a restaurant, a pub or similar retail business establishments serving alcoholic beverages. Similarly, the attributes 316 of the alcoholic beverage offerings typically include a specific brand of alcohol, a recipe of a drink, ingredients of a beverage, a price of a beverage, a quantity of a serving, a producer of an alcohol or beverage, a geographic indication of origin of an alcohol, a serving style, and/or the like.

The relational database management computer system 302 is further configured to provide a user GUI 322, via the Internet 312, to a suitable processing system 320 of a user 318, whereby a user 318 is able to, in substantial real-time i) provide a GNSS identifier 324 indicative of a geographic location of the user 318, ii) search the relational database 304 for desired alcoholic beverage offerings 316, and iii) receive, from the relational database management computer system 302, a visualisation of purveyors offering the desired alcoholic beverage offerings within a predetermined distance from the geographic location of the user.

In this manner, a plurality of users 318 is able to search a plurality of purveyors' 306 alcoholic beverage offerings 316 (as included in the respective purveyor unique profiles 314) and to receive real-time indications of availability and associated attributes 316 based on geographic location.

In different embodiments, the GNSS identifier 324 indicative of a geographic location of the user 318 can comprise an output from a GNSS sensor or module of the suitable processing system 320 of the user and/or a postcode entry via the user GUI.

The visualisation of purveyors provided to a user 318 typically comprises an interactive map showing the relative position of such purveyors 306 in relation to the geographical location of the user. In one embodiment, the visualisation of purveyors includes a list of purveyors sortable according to any of the attributes, e.g. price, location, distance, etc.

In one example, the user GUI 322 may be configured to include promotional information from at least one purveyor. Similarly, the user GUI 322 may be configured to allow a user 318 to comment on an alcoholic beverage offering of a purveyor, said comment stored as an attribute 316 within the relational database 304, e.g. a review of the beverage offering.

Similarly, in one embodiment, the system 300 may be configured to facilitate promotional communication between the purveyor system 308 and the user GUI 322. Such communication may take a variety of forms, including API integration with social media accounts to allow sharing of information, promotions and reviews, ride sharing apps to facilitate travel to a particular purveyor, as well as a feed of current and/or upcoming promotions that may be of interest to a user 318. For example, promotion of rare or inexpensive alcoholic beverages may provide a competitive advantage to a purveyor 306 within the market, or the like.

Additionally, the system 300 may also be configured to allow a purveyor 306 to advertise directly to users 318. For example, once a purveyor 306 registers a purveyor profile 314, said purveyor 306 is able to enter their alcoholic beverage offerings and associated attributes, e.g. types of drinks with prices. The purveyors 306 can then upload promotions of their offerings, e.g. espresso martinis for $9 on Wednesday night. Such promotions are sent to users 318 via a suitable feed, e.g. ‘bar feed’ via the user GUI 322 or similarly integrated social media feeds. In this manner, a user 318 can view all purveyors' posts' of promotions within their chosen location. The user 318 also may choose to follow a particular purveyor similar to other social media platforms, or the like. Such described promotional and communication features may be configured on a subscription basis, where additional functionality is provided upon payment of periodic subscription charges.

For example, in one embodiment, a user 318 may subscribe to a notification service once a specified beverage is available and/or on special within a specific geographic area, e.g. $0.99/month to follow one drink of choice, $1.99/month to follow up to 3 drinks of choice, $3.99/month to follow unlimited drinks of choice, or the like).

In one embodiment, the system 300 may further be configured to provide a ‘tour’ of purveyors or venues offering a user-selectable beverage, i.e. an organised real-time indication of availability. For example, a user 318 can specify a specific beverage and the system 300 can calculate a list of purveyors or venues within a predetermined geographic distance from the user, along with a route to follow to facilitate a ‘pub crawl’ where the user 318 can travel between venues to partake in the selected type or style of beverage specified. Such a virtual tour may also be facilitated via suitable API integration with ride sharing apps, or the like.

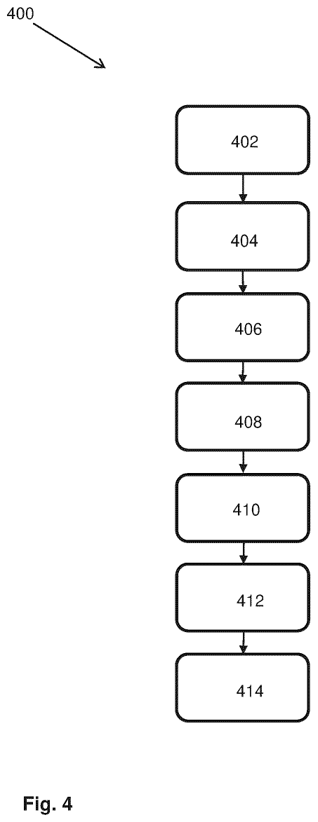

The present invention further extends to a method 400 for alcoholic beverage procurement, as diagrammatically indicated by method blocks in FIG. 4. Such a method 400 typically comprises the steps of providing 402 a relational database management computer system arranged in signal communication with a relational database, and providing 404 a purveyor GUI, via the relational database management computer system, to a suitable processing system of an alcoholic beverage purveyor.

Method 400 then generally features the steps of receiving 406 a unique profile registration from such a purveyor, said profile populated with alcoholic beverage offerings that comprise various attributes within said relational database, and providing 408 a user GUI, via the relational database management computer system, to a suitable processing system of a user.

Method 400 then includes the steps of receiving 410, from the user processing system, a GNSS identifier indicative of a geographic location of the user in substantial real-time, receiving 412, from the user processing system, a search query for desired alcoholic beverage offerings, executing a search 412 on the relational database according to such search query, and providing 414, via the relational database management computer system, a visualisation of purveyors offering said desired alcoholic beverage offerings within a predetermined distance from the geographic location of the user.

In practice, the skilled addressee is to appreciate that the system 300 and associated method 400 enable a user 318 to search for specific alcoholic beverages according to specific beverage offerings. For example, a whiskey enthusiast may wish to locate a nearby purveyor of a specific cocktail, such as an ‘old fashioned’ made with a specific brand of whiskey, or according to a specific recipe, or the like. The system 300 allows a user to search and locate a suitable purveyor which offers the required cocktail based on a geographic location of the user. If there are numerous results for suitable purveyors, the user 318 is able to sort the results according to price, distance, etc.

The Applicant believes it advantageous that the invention described herein allows for an elegant and efficient way to provide better guidance to alcoholic beverage enthusiasts, particularly where enthusiasts have an affinity for a specific type or brand of alcoholic beverage or beverage recipe. The present invention enables a user to locate an alcoholic beverage purveyor in real-time according to any suitable beverage offerings and to receive a visualisation of such beverage offerings based on the user's geographic position in relation to those of the respective beverage purveyors. The invention further facilitates fast and efficient on-demand beverage locating, allows purveyors 306 to communicate directly with users 318, as well as for users 318 to link the system 300 to existing social media accounts in order to share their experiences with family and friends.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. An alcoholic beverage procurement system comprising a relational database management computer system arranged in signal communication with a relational database and configured to:
provide a purveyor GUI, via the Internet, to a suitable processing system of an alcoholic beverage purveyor whereby such a purveyor is able to:
i) register a unique profile; and
ii) populate said profile with alcoholic beverage offerings that comprise various attributes within said relational database; and
provide a user GUI, via the Internet, to a suitable processing system of a user, whereby such a user is able to, in substantial real-time:
i) provide a GNSS identifier indicative of a geographic location of the user;
ii) search the relational database for desired alcoholic beverage offerings; and
iii) receive, from the relational database management computer system, a visualisation of purveyors offering said desired alcoholic beverage offerings within a predetermined distance from the geographic location of the user;
wherein a plurality of users is able to search a plurality of purveyors' alcoholic beverage offerings and receive real-time indications of availability and associated attributes based on geographic location.

2. The system of claim 1, wherein the alcoholic beverage purveyor is selected from a non-exhaustive group consisting of a bar, a tavern, a club, a restaurant, a pub or retail business establishments serving alcoholic beverages.

3. The system of either of claim 1, wherein the attributes of the alcoholic beverage offerings are selected from a non-exhaustive group consisting of brand, recipe, ingredients, price, quantity, producer, geographic indication of origin, serving style, and geographic location.

4. The system of claim 1, wherein the GNSS identifier indicative of a geographic location of the user comprises an output from a GNSS module of the suitable processing system of the user and/or a postcode entry via the user GUI.

5. The system of claim 1, wherein the visualisation of purveyors comprises an interactive map showing the relative position of such purveyors in relation to the geographical location of the user.

6. The system of claim 1, wherein the visualisation of purveyors includes a list of purveyors sortable according to any of the attributes.

7. The system of claim 1, wherein the suitable processing system of either the purveyor and/or the user comprises a mobile phone handset, a tablet, or a personal computer.

8. The system of claim 1, wherein the user GUI is configured to include promotional information from at least one purveyor.

9. The system of claim 1, wherein the user GUI is configured to allow a user to comment on an alcoholic beverage offering of a purveyor, said comment stored as an attribute within the relational database.

10. A computer-implemented method for alcoholic beverage procurement requiring a relational database management computer system arranged in signal communication with a relational database, said management computer system configured to perform the steps of:
providing a purveyor GUI, via the Internet, to a suitable processing system of an alcoholic beverage purveyor whereby such a purveyor is able to:
i) register a unique profile; and
ii) populate said profile with alcoholic beverage offerings that comprise various attributes within said relational database; and
providing a user GUI, via the Internet, to a suitable processing system of a user, whereby such a user is able to, in substantial real-time:
i) provide a GNSS identifier indicative of a geographic location of the user;
ii) search the relational database for desired alcoholic beverage offerings; and
iii) receive, from the relational database management computer system, a visualisation of purveyors offering said desired alcoholic beverage offerings within a predetermined distance from the geographic location of the user;
wherein a plurality of users is able to search a plurality of purveyors' alcoholic beverage offerings and receive real-time indications of availability and associated attributes based on geographic location.

11. The method of claim 10, wherein the alcoholic beverage purveyor is selected from a non-exhaustive group consisting of a bar, a tavern, a club, a restaurant, a pub or retail business establishments serving alcoholic beverages.

12. The method of either of claim 10, wherein the attributes of the alcoholic beverage offerings are selected from a non-exhaustive group consisting of brand, recipe, ingredients, price, quantity, producer, geographic indication of origin, serving style, and geographic location.

13. The method of claim 10, wherein the GNSS identifier indicative of a geographic location of the user comprises an output from a GNSS module of the suitable processing system of the user and/or a postcode entry via the user GUI.

14. The method of claim 10, wherein the visualisation of purveyors comprises an interactive map showing the relative position of such purveyors in relation to the geographical location of the user.

15. The method of claim 10, wherein the visualisation of purveyors includes a list of purveyors sortable according to any of the attributes.

16. The method of claim 10, wherein the suitable processing system of either the purveyor and/or the user comprises a mobile phone handset, a tablet, or a personal computer.

17. The method of claim 10, wherein the user GUI is configured to include promotional information from at least one purveyor.

18. The method of claim 10, wherein the user GUI is configured to allow a user to comment on an alcoholic beverage offering of a purveyor, said comment stored as an attribute within the relational database.

19. A method for alcoholic beverage procurement comprising the steps of:
providing a relational database management computer system arranged in signal communication with a relational database;
providing a purveyor GUI, via the relational database management computer system, to a suitable processing system of an alcoholic beverage purveyor;
receiving a unique profile registration from such a purveyor, said profile populated with alcoholic beverage offerings that comprise various attributes within said relational database; and
providing a user GUI, via the relational database management computer system, to a suitable processing system of a user;
receiving, from the user processing system, a GNSS identifier indicative of a geographic location of the user in substantial real-time;
receiving, from the user processing system, a search query for desired alcoholic beverage offerings; and
executing a search on the relational database according to such search query; and
providing, via the relational database management computer system, a visualisation of purveyors offering said desired alcoholic beverage offerings within a predetermined distance from the geographic location of the user.

20. (canceled)
